(19) United States
(12) Patent Application Publication
(10) Pub. No.: US 2005/0268720 A1
(43) Pub. Date: Dec. 8, 2005

(54) Matrix switched phased array ultrasonic guided wave system

(75) Inventor: Michael J. Quarry, Pleasanton, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/143,544

(22) Filed: Jun. 1, 2005

Related U.S. Application Data
(60) Provisional application No. 60/576,942, filed on Jun. 3, 2004.

(51) Int. Cl. G01N 29/04

(52) U.S. Cl. 73/627

(57) ABSTRACT

A system for nondestructively evaluating a sample. An ultrasonic array is used for directing and receiving guided waves to the sample. A matrix switch is used to sequence through the array of transducers and reconstruct the modal waveform by introducing the appropriate time delay for the desired mode. The sequencing sweeps through the dispersion space of all possible guided wave modes for a given plate. The sequencing is used to determine the parameters (frequency and time delay) that will excite the optimal guided wave mode for inspecting a given structure.

### CROSS-REFERENCE TO RELATED APPLICATIONS

This application claims the benefit of U.S. Provisional Patent Application No. 60/576,942 filed Jun. 3, 2004 by Michael J. Quarry titled “Matrix Switched Phased Array Ultrasonic Guided Wave System.” U.S. Provisional Patent Application No. 60/576,942 filed Jun. 3, 2004 is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to ultrasonic guided waves and more particularly to a matrix switched phased array ultrasonic guided wave system.

2. State of Technology

U.S. Pat. No. 6,581,014 issued Jun. 17, 2003 to James A. sills and Christian J. Schwartz for an apparatus and method for analysis of guided ultrasonic waves provides the following state of technology information: Ultrasonic wave inspection techniques are useful for many Non-Destructive Evaluation (NDE) applications. These techniques typically involve transmitting a narrow band ultrasonic frequency interrogation signal down the length of an object and analyzing the reflected or “inspection” signal for the presence of material boundaries or flaws (e.g., surfaces, joints, welds, cracks, etc.) in the object. Defects in the object that cannot be seen by visual inspection can often be detected by analyzing the inspection signal. Thus, ultrasonic wave inspection techniques can provide a cost effective solution for detecting defects in many objects such as railroad rails, stranded cables, pipes, and the like, from a single set up location.

Generally, in the field of acoustics, there are two fundamental types of waves that propagate through material: pressure waves and shear waves. These waves are called “bulk” waves and they propagate through the material at a constant velocity over all frequencies, including ultrasonic frequencies. An incident ultrasonic bulk wave transmitted along an object will be reflected from one end of the object so as to arrive at a fixed time at the transmission location according to a predictable, fixed travel time period.

Bulk waves are used to inspect on a point-by-point basis. For structures such as plates, guided waves are another mode of propagation. Guided waves inspect by propagating along the thickness as opposed to through the thickness in the case of bulk waves. Guided waves depend on the material properties and thickness of the plate. Many modes exist at a single frequency. Each mode travels at a different wave speed and has unique properties in its reflection from defects such as corrosion or cracking. Guided waves are useful for inspecting structures such as aircraft fuselages, tubing, and piping because they propagate tens of meters and can detect cracks, corrosion, and pitting.

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a system for nondestructively evaluating a sample. An ultrasonic array is used for directing and receiving guided waves to the sample. A matrix switch is used to sequence through the array of transducers and reconstruct the modal waveform by introducing the appropriate time delay for the desired mode. In one embodiment of the present invention an apparatus for nondestructively evaluating a sample comprises an ultrasonic array for directing and receiving guided waves to the sample, a matrix switch, a switch controller, a computer and software interface, and a tone-burst source pulser/receiver.

The present invention has many uses. For example the present invention has use for nondestructive evaluation of composites, aircraft wing and fuselage, and steel plates. The present invention also has use for nondestructive evaluation of weapons and NIF targets and the nondestructive evaluation of nuclear materials.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1A illustrates a system of the present invention.

FIG. 1B shows each transmitter 1 through 8 pulsed with a high power (1000 V) tone-burst of several cycles.

FIG. 2 is a schematic of the matrix switch and how it functions.

FIG. 3 illustrates a system of the present invention utilizing guided waves for inspecting structures that consist of multiple layers.

FIG. 4 a schematic showing a sample of alumina-epoxy-aluminum with a notch machined into the aluminum layer to simulate a crack in the bottom layer.

FIG. 5 shows a sample RF waveform at 475 kHz and the detection of the notch.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Ultrasonic guided waves can be utilized to nondestructively inspect structures such as plates by launching a guided wave mode from one position and receiving it at the same or different position. A challenge is created because many modes can exist in the plate that travel with different speeds. The modes are dependent upon the material properties and thickness of the plate. A single dominant mode must be excited to avoid confusion that is produced from multiple modes being excited simultaneously. Moreover, the optimal mode for inspecting the plate is unknown due to complicated and unknown geometries of flaws such as cracks and corrosion. A suitable mode must be found experimentally by searching through all possible modes. To do this requires a probe that is designed to sweep through all possible modes in the dispersion space.

Two methods currently exist exciting various modes. One is a variable angle transducer that is placed on a wedge material, typically Plexiglas. Manually controlling the angle excites a mode on the dispersion curves with a phase velocity given by Snell's Law, in Equation 1, where θ is the angle of incidence, and at a frequency given by the frequency of the tone-burst input.

$${V}_{ph} = \frac{{V}_{Pl}}{sin θ} \qquad [ Equation 1 ]$$

A horizontal activation line is generated for a given angle. Thus, incrementally changing the angle of incidence and frequency of the tone-burst enables a sweep of all the modes. The approach is limited to phase velocities greater than the velocity in the wedge material. As a result, many modes in materials such as special nuclear materials or composites cannot be excited because of their low velocities.

A second method to excite modes uses a linear array of transducers. The linear array excites a dominant mode that corresponds to a wavelength equal to the spacing of the elements. As frequency is swept the phase velocity of the excited mode increases linearly with a slope given by the wavelength. Hence, modes are excited along a diagonal activation line as frequency is swept. The limitation of this approach is that not all modes can be excited because the activation is constrained to a wavelength prescribed by the spacing.

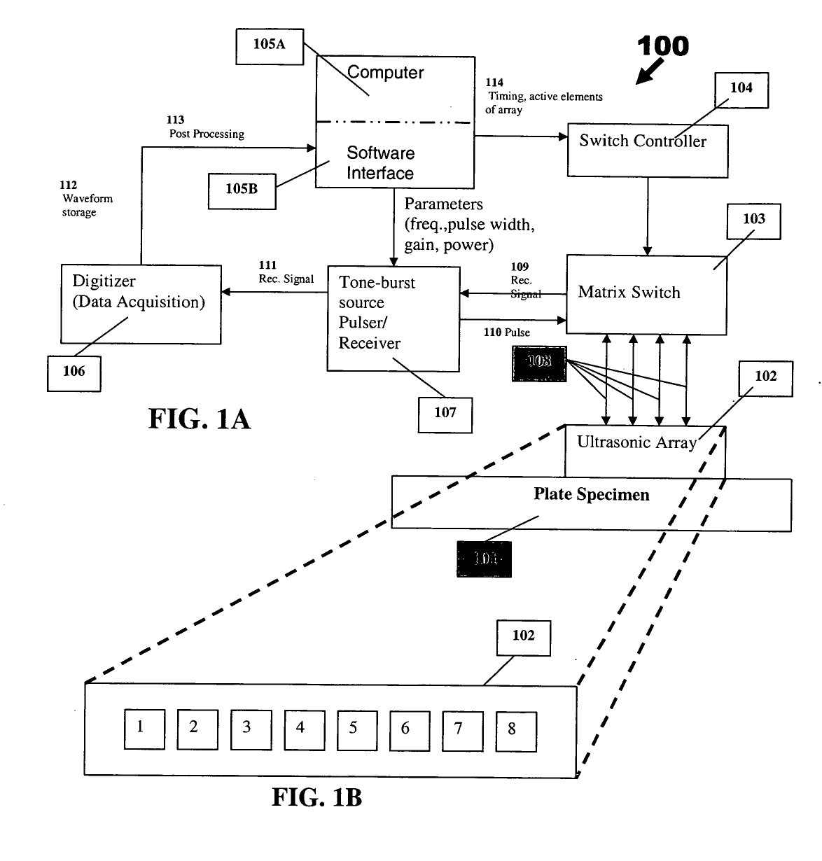

Referring now to the drawings and in particular to FIG. 1A, a system of the present invention is illustrated. The system is designated generally by the reference numeral 100. The system 100 uses a matrix switch 103 in a system for nondestructively evaluating a sample 101. An ultrasonic array 102 is used for directing and receiving guided waves to the sample 101. The matrix switch 103 is used to sequence through the array of transducers 102 and reconstruct the modal waveform by introducing the appropriate time delay for the desired mode. The sequencing sweeps through the dispersion space of all possible guided wave modes for a given plate. The sequencing is used to determine the parameters (frequency and time delay) that will excite the optimal guided wave mode for inspecting a given structure.

As illustrated in FIG. 1A, the system 100 is shown in a position to nondestructively inspect the plate specimen 101. The system 100 includes the following structural components: an ultrasonic array 102, a matrix switch 103, a switch controller 104, a computer 105A and software interface 105B, a digitizer (Data Acquisition) 106, and a tone-burst source pulser/receiver 107. The system 100 utilizes the ultrasonic array 102 of transducer elements, the high power tone-burst pulser and receiver 107, the matrix switch 102, the switch controller 104, the digitizer 106, and the personal computer 105A operated through the software interface 105B to nondestructively inspect the plate specimen 101.

The system 100 for nondestructively evaluating a sample comprises an ultrasonic array 102 for directing and receiving guided waves 108 to the sample 101, a matrix switch 103, a switch controller 104, a computer and software interface 105A and 105B, a tone-burst source pulser and receiver with amplification 107. In one embodiment the ultrasonic array 102 for directing and receiving guided waves to the sample 101 comprises an array of piezoelectric elements. In another embodiment the ultrasonic array 102 for directing and receiving guided waves to the sample 101 comprises an array of electromagnetic acoustic transducers. In another embodiment the ultrasonic array 102 for directing and receiving guided waves to the sample 101 has an annular shape for radial wave propagation. In another embodiment the ultrasonic array 102 for directing and receiving guided waves to the sample 101 comprises shear wave transducers for producing horizontal shear type guided modes. In another embodiment the ultrasonic array 102 for directing and receiving guided waves to the sample 102 comprises a first ultrasonic array for transmitting guided waves and a second ultrasonic array for receiving the guided waves. In another embodiment the ultrasonic array 102 for directing and receiving guided waves to the sample 102 comprises ultrasonic elements mounted in a flexible fixture.

The structural components of the system 100 having been described, the operation of the system 100 will now be considered. The system 100 uses the matrix switch 103 to sequence through the array of transducers 102 and reconstruct the modal waveform by introducing the appropriate time delay for the desired mode. The matrix switch 103 allows for any combination of ultrasonic array elements to be used as transmitters or receivers as illustrated by the double headed arrows 108. The resulting waveform is comprised primarily of the desired mode in the waveguide. The dispersion space is swept by sweeping frequency and implementing the appropriate time delays for each mode. At a particular frequency, the time delays can be introduced to shift the phase velocity to a higher or lower phase velocity.

Referring now to FIG. 1B, each transmitter 1 through 8 is pulsed with a high power (1000 V) tone-burst of several cycles. The frequency, number of cycles, and amplitude are software controlled and input into the pulser. Ultrasound is generated in the plate under investigation and propagates. It is reflected by any flaws or discontinuities and arrives at an array that acts to detect the sound. The data is stored. The switch then switches to the next combination of transmitter and receiver for data to be collected. The loop continues until the sequence is complete. The received RF waveforms are then phased by introducing the appropriate time delays for each waveform. The appropriate time delay can be determined from constructive interference. Constructive interference occurs when

$${t}_{d} = \frac{s}{{V}_{ph}} , \qquad [ Equation 2 ]$$

where s is the spacing and Vph is the phase velocity of the desired mode. Summation of the waveforms with the appropriate phase yields a waveform with the desired mode dominant. This procedure is repeated for the next mode and continued until the entire dispersion space has been incrementally swept.

The system 100 uses an RF narrowband signal such as a tone-burst that is switched between multiple channels and sent to an ultrasonic array excite guided wave modes to nondestructively evaluate waveguide structures such as plates, tubes, and multi-layered structures. The guided wave modes excited propagate along the waveguide and are reflected from flaws such as cracks, voids, and corrosion. Finding a suitable mode for inspection requires that all modes be investigated. Guided wave modes are excited one by one until all modes have been used for inspection. This is accomplished by using the array of transducers 102 that send and receive through a sequence that switched through a matrix switch 103. The matrix switch 103 allows for any combination of elements of the array to be pulsed or received. The array 103 is then phased by applying a time delay to the received signals and reconstructing the total wave mode.

Effectively inspecting of plate like structures such as the plate specimen 101 with Lamb waves requires precise control over the excitation and reception of modes suitable for detecting a given flaw. Flaws such as corrosion and cracking often have complicated geometries and orientations. As a result, suitable modes for inspection are unknown and must be determined experimentally by trying each mode. Many modes are possible, but only a select few will yield success. Hence, an apparatus must be capable of trying all modes. This can be achieved by phasing an array of transducers. However, multi-channel electronic systems for creating phase differences (time delays) between the individual elements of an ultrasonic array with a high power tone-burst input have been problematic. Problems occur from channel-to-channel variations in amplitude and frequency, inaccuracies in time delays, and maintaining coherence between channels. One approach has been to use multiple sources that are delayed, but this has suffered from the problems as outlined above. This approach uses a single source that is matrix switched using computer control. Each channel is pulsed one at a time in a sequential fashion rather than simultaneously. The time delays are then introduced as a post processing routine of the data. The matrix switch 102 allows for any combination of senders and receivers to be used. As a result, no circuitry is required for introducing time delays into each channel, and variations in channels do not occur since there is a single source. Furthermore, more precise time delays (phases) can be applied to the array 102.

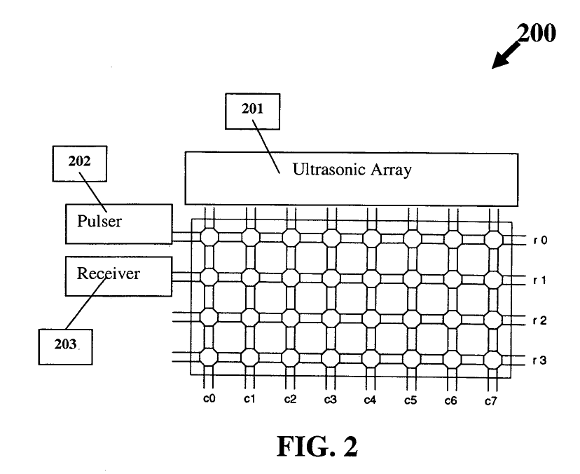

Referring now to FIG. 2, a schematic of the matrix switch and how it functions is shown. The matrix switch illustrated in FIG. 2 is designated generally by the reference numeral 200. The matrix switch 200 operates as a matrix of individual switches that can be opened or closed. An array of sensors 201 can be connected to the columns c0 through c7 of the matrix switch, and a pulser 202, receiver 201, or multiple devices can be connected to the rows. A switch is present at each row r0 through r3/column c0 through c7 combination. Each element in the array 201 can then be either connected to the pulser 202, the receiver 203, or neither. A controller card can open or close the switches and be controlled through software. A sequence may be programmed to cycle through the necessary combinations. Arrays with different spacings can also be achieved by using elements that are closely spaced (0.1 mm) and pulsing those elements that form an array of the desired spacing.

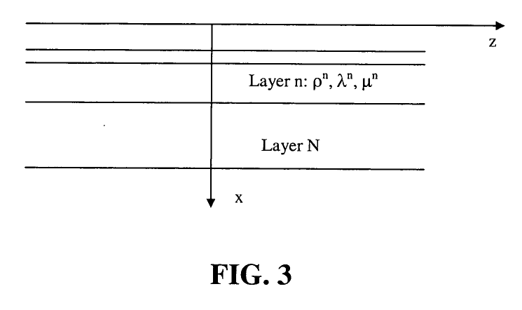

Referring now to FIG. 3, a system of the present invention utilizing guided waves for inspecting structures that consist of multiple layers is illustrated. The system is designated generally by the reference numeral 300. Advances have been made in recent years using guided waves to inspect single layer structures, such as pipes, tubes, and aircraft structures. Multi-layered structures present many new aspects to guided wave propagation. A theoretical understanding of what modes exist, how do the modes behave, and what factors influence them needs to be acquired for many applications. Experiments were carried out to evaluate potential for practical applications. Examples of practical applications include coated pipes, composites, diffusion bonded aircraft structures, and microelectronic structures.

The system 300 was developed from is a fundamental study of ultrasonic guided waves in multi-layered plates. Experiments were conducted on multi-layered plates to demonstrate defect detection in layer of interest of a multi-layered structure by preferentially exciting modes with sufficient energy in that layer. Analysis of the dispersion curves show that some modes are more attractive candidates than others based on their displacements and energy distribution across the structure. Experimental results show that sweeping frequency and phase velocity can be performed to find suitable modes for inspecting a layer of interest for a given multi-layered structure.

Multi-layered structures pose many interesting problems and challenges for nondestructive evaluation. Guided waves offer a powerful solution that requires understanding of the behavior of modes within multi-layered structures for various applications. Many forms of guided wave propagation can occur in multi-layered structures including free modes, “leaky” waves, interfacial waves, and dispersive surface waves. Considerable work has been performed on seismology applications involving leaky waves in rock layers. At the other end of the spectrum, “leaky” Lamb type waves have been used in high frequency acoustic microscopy for characterized layered structures. Most nondestructive evaluation applications require intermediate wavelengths of fractions of an inch to several inches.

One must first understand the wave propagation that takes place within the structure. Theoretically, this can be analyzed by applying the boundary conditions and deriving the dispersion equation to determine the modes and their physical characteristics. In some cases, the dispersion curves cannot be precisely computed. Adhesives are common in multi-layered structures and often do not have a constant thickness. The precise boundary conditions may be unknown or difficult to determine. Modeling the behavior of modes can provide valuable information about selecting suitable modes for inspection. However, experimental development of a successful inspection technique does not require precise calculations of the dispersion properties of the multi-layered structure.

Consider the geometry for an N-layer plate structure as shown in FIG. 3. An N-layer structure has N-1 interfaces and free surfaces at the top and bottom of the structure. The n^{th} layer consists of material properties of density, ρⁿ, and Lame constants, πⁿ, and μⁿ. The thickness of each layer is given as bⁿ. The displacement vector uⁿ in each layer must satisfy the equations of motion, which can be written for the n^{th} layer as

$${μ}^{n} {∇}^{2} {u}^{n} + ( {λ}^{n} + {μ}^{n} ) ∇ ( ∇ \cdot {u}^{n} ) = {ρ}^{n} \frac{{\partial }^{2} {u}^{n}}{\partial {t}^{2}} . \qquad [ Equation 3 ]$$

A set of N differential equations is created by applying Equation (1) to each layer. A harmonic wave dependence is assumed.

Boundary conditions must be imposed on the interfaces. Specifically, the displacement and traction fields must be continuous across the interface. The (N-1) interfaces yield 4(N-1) equations and the traction-free boundary conditions at the top and bottom surfaces produces 4N equations. Each layer possesses 4 unknowns. A system is created with 4N equations in 4N unknowns that can be written as

$$[ \begin{matrix}{A}_{11} & {A}_{12} & … & {A}_{1 ( 4 N )} \\ {A}_{21} & {A}_{22} & … & ⋮ \\ ⋮ & ⋮ & ⋰ & ⋮ \\ {A}_{( 4 N ) 1} & … & … & {A}_{( 4 N ) ( 4 N )}\end{matrix} ] [ \begin{matrix}{B}_{1}^{1} \\ {B}_{2}^{1} \\ ⋮ \\ {B}_{N}^{N}\end{matrix} ] = [ \begin{matrix}0 \\ 0 \\ ⋮ \\ 0\end{matrix} ] . \qquad [ Equation 4 ]$$

For nontrivial solutions of Equation (2) the determinant of matrix A must be set to zero. This generates the dispersion relation for the N-layered plate structure in Equation 5 as
Det|A|=0. [Equation 5]

Solving Equation 5 for the roots generates the dispersion curves for the multi-layered structure. Only the real roots are considered because imaginary roots produce evanescent waves. The dispersion curves for an alumina-epoxy-aluminum structure with 6.35 mm of alumina, 0.1 mm epoxy, and 2 mm aluminum were used. The dispersion curves provide a basis for conducting experiments, interpreting data and designing sensors for optimal inspection capabilities.

Utilizing guided waves for inspection of multi-layered structures requires consideration of several physical processes. These include the mode shapes, scattering of modes, and the characteristics of the source and receiver. Mode shapes show how physical characteristics of the mode vary across the thickness. A mode propagates with a fixed unique displacement pattern across the thickness. This property is significant; because it shows how differently modes can behave. A mode with a most of its energy in the top layer and little in the bottom will not be effective at detecting flaws in the bottom layer.

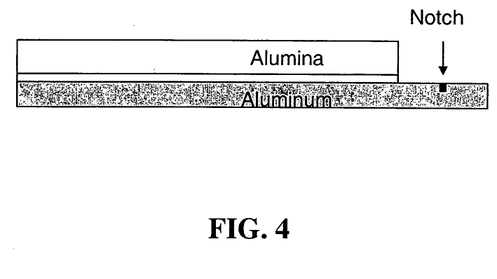

A sample of alumina-epoxy-aluminum was constructed. The sample has a transition from the multi-layer to a single layer structure. A notch was machined into the aluminum layer to simulate a crack in the bottom layer. The notch was approximately 30% through the wall of the aluminum. A schematic is shown in FIG. 4. The transition is common to many practical applications such as lap joints in aircraft structures. Frequently, one is trying to inspect a single layer with access in the multi-layered section or vice versa. The transition will act as a reflector, since it is a disturbance of the waveguide.

Experiments were conducted using a variable angle wedge to sweep through the dispersion curves. A tone-burst was used to drive the transducer. The frequency of the tone-burst was incrementally swept in 5 kHz steps. The angle of incidence of the wedge was incrementally adjusted in single degree steps from 10 to 70 degrees. This is generally a slow process and not fast enough for most practical applications. However, it is possible to reduce the process for field use by identifying a small set of ranges based on experimental development in the laboratory.

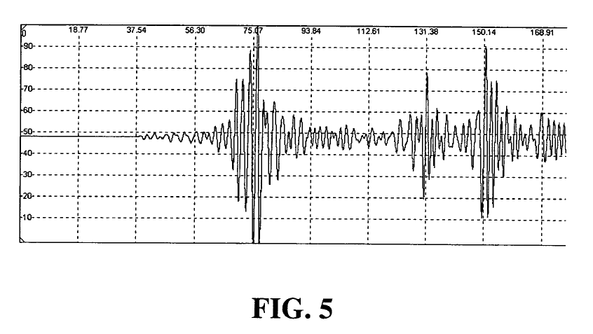

Sweeping the dispersion space with the angle beam enabled the signal-to-ratio of the reflection from the notch to be maximized. A mode at 475 kHz and a phase velocity of 5.29 km/s was found to produce good signal-to-noise. FIG. 5 shows a sample RF waveform at 475 kHz and the detection of the notch. Two wedges were used in a pulse-echo setup to eliminate any ringing noise in the wedge. A group velocity of 3.3 km/s was observed and verified with the group velocity dispersion curves. Group velocity dispersion curves assist in identifying modes as well as localizing flaws.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. An apparatus for nondestructively evaluating a sample, comprising:
an ultrasonic array for directing and receiving guided waves to the sample,
a matrix switch,
a switch controller,
a computer and software interface,
a tone-burst source pulser, and
a receiver with amplification

2. The apparatus for nondestructively evaluating a sample of claim 1 wherein the sample is a plate or plate-like structure and wherein said ultrasonic array directs and receives guided waves to the plate or plate-like structure.

3. The apparatus for nondestructively evaluating a sample of claim 1 wherein the sample is a plate-like structure and wherein said ultrasonic array directs and receives guided waves to the plate-like structure.

4. The apparatus for nondestructively evaluating a sample of claim 1 wherein the sample is a plate and wherein said ultrasonic array directs and receives guided waves to the plate.

5. The apparatus for nondestructively evaluating a sample of claim 1 wherein the sample is a plate and wherein the plate comprises multiple layers of materials and wherein said ultrasonic array directs and receives guided waves to the multiple layers of materials.

6. The apparatus for nondestructively evaluating a sample of claim 1 wherein the sample is a plate and wherein the plate comprises multiple layers of aluminum-epoxy-aluminum and wherein said ultrasonic array directs and receives guided waves to the multiple layers of aluminum-epoxy-aluminum.

7. The apparatus for nondestructively evaluating a sample of claim 1 wherein said ultrasonic array for directing and receiving guided waves to the sample comprises an array of piezoelectric elements.

8. The apparatus for nondestructively evaluating a sample of claim 1 wherein said ultrasonic array for directing and receiving guided waves to the sample comprises an array of electromagnetic acoustic transducers.

9. The apparatus for nondestructively evaluating a sample of claim 1 wherein said ultrasonic array for directing and receiving guided waves to the sample has an annular shape for radial wave propagation.

10. The apparatus for nondestructively evaluating a sample of claim 1 wherein said ultrasonic array for directing and receiving guided waves to the sample comprises shear wave transducers for producing horizontal shear type guided modes.

11. The apparatus for nondestructively evaluating a sample of claim 1 wherein said ultrasonic array for directing and receiving guided waves to the sample comprises a first ultrasonic array for transmitting guided waves and a second ultrasonic array for receiving the guided waves.

12. The apparatus for nondestructively evaluating a sample of claim 1 wherein said ultrasonic array for directing and receiving guided waves to the sample comprises ultrasonic elements mounted in a flexible fixture.

13. An apparatus for nondestructively evaluating a sample, comprising:
ultrasonic array means for directing and receiving guided waves to the sample,
a matrix switch,
a switch controller,
a computer and software interface,
a tone-burst source pulser, and
a receiver with amplification

14. The apparatus for nondestructively evaluating a sample of claim 13 wherein the sample is a plate or plate-like structure and wherein said ultrasonic array means directs and receives guided waves to the plate or plate-like structure.

15. The apparatus for nondestructively evaluating a sample of claim 13 wherein the sample is a plate-like structure and wherein said ultrasonic array means directs and receives guided waves to the plate-like structure.

16. The apparatus for nondestructively evaluating a sample of claim 13 wherein the sample is a plate and wherein said ultrasonic array means directs and receives guided waves to the plate.

17. The apparatus for nondestructively evaluating a sample of claim 13 wherein the sample is a plate and wherein the plate comprises multiple layers of materials and wherein said ultrasonic array means directs and receives guided waves to the multiple layers of materials.

18. The apparatus for nondestructively evaluating a sample of claim 13 wherein the sample is a plate and wherein the plate comprises multiple layers of aluminum-epoxy-aluminum and wherein said ultrasonic array means directs and receives guided waves to the multiple layers of aluminum-epoxy-aluminum.

19. The apparatus for nondestructively evaluating a sample of claim 13 wherein said ultrasonic array means for directing and receiving guided waves to the sample comprises an array of piezoelectric elements.

20. The apparatus for nondestructively evaluating a sample of claim 13 wherein said ultrasonic array means for directing and receiving guided waves to the sample comprises an array of electromagnetic acoustic transducers.

21. The apparatus for nondestructively evaluating a sample of claim 13 wherein said ultrasonic array means for directing and receiving guided waves to the sample has an annular shape for radial wave propagation.

22. The apparatus for nondestructively evaluating a sample of claim 13 wherein said ultrasonic array means for directing and receiving guided waves to the sample comprises shear wave transducers for producing horizontal shear type guided modes.

23. The apparatus for nondestructively evaluating a sample of claim 13 wherein said ultrasonic array means for directing and receiving guided waves to the sample comprises a first ultrasonic array for transmitting guided waves and a second ultrasonic array for receiving the guided waves.

24. The apparatus for nondestructively evaluating a sample of claim 13 wherein said ultrasonic array means for directing and receiving guided waves to the sample comprises ultrasonic elements mounted in a flexible fixture.

25. A method for nondestructively evaluating a sample for a defect, comprising the steps of:
using an ultrasonic array having an axis for directing and receiving guided waves to the sample, and
using a matrix switch to sequence through the array of transducers with the axis of the array parallel to the propagation direction and reconstruct the modal waveform by introducing the appropriate time delays to search through the dispersion space of guided waves for sample and determine the optimal mode for inspection, where the optimal mode is determined by the maximum signal-to-noise ratio for a reflection from the defect

26. A method for nondestructively evaluating a sample of claim 25 wherein the sample is a plate or plate-like structure and wherein said ultrasonic array directs and receives guided waves to the plate or plate-like structure.

27. A method for nondestructively evaluating a sample of claim 25 wherein the sample is a plate-like structure and wherein said ultrasonic array directs and receives guided waves to the plate-like structure.

28. A method for nondestructively evaluating a sample of claim 25 wherein the sample is a plate and wherein said ultrasonic array directs and receives guided waves to the plate.

29. A method for nondestructively evaluating a sample of claim 25 wherein the ultrasound is generated by an array of piezoelectric elements at the appropriate frequency determined by the sample's material properties and thickness.

30. A method for nondestructively evaluating a sample of claim 25 wherein said step of using an ultrasonic array for directing and receiving guided waves to the sample produces horizontal shear type guided modes.

31. A method for nondestructively evaluating a sample of claim 25 wherein said step of using an ultrasonic array for directing and receiving guided waves to the sample uses a first ultrasonic array for transmitting guided waves to the sample and uses a second ultrasonic array for receiving guided waves from the sample.
